(19) United States
(12) Patent Application Publication
(10) Pub. No.: US 2016/0072585 A1
(43) Pub. Date: Mar. 10, 2016

(54) Method Of Creating An Optical Link Among Devices

(71) Applicants: Jonathan D. Halderman, Sunnyvale, CA (US); Karl Jiefu Ma, Tiburon, CA (US)

(72) Inventors: Jonathan D. Halderman, Sunnyvale, CA (US); Karl Jiefu Ma, Tiburon, CA (US)

(73) Assignee: Helios Lightworks, LLC, Sunnyvale, CA (US)

(21) Appl. No.: 14/480,589

(22) Filed: Sep. 8, 2014

(51) Int. Cl. H04B 10/25

(52) U.S. Cl. CPC H04B 10/2504

(57) ABSTRACT

A method for creating optical links between two or more optical devices. The method eliminates the need for precision active alignment of the individual components to be joined. After the components to be joined have been bonded in place on a package the optical axis of each component is found and an optical link among the components is fabricated in-place.

### BACKGROUND OF THE INVENTION

In current practice for photonic device packaging, there generally exists a need to create optical links among microscopic optical components including fiber cores, photonic waveguides, light sources, and light sensors on one device to similar microscopic features on another device.

These optical links generally take the form of an optical core material which is transparent in the wavelength to be transmitted. This optical core material is surrounded by a transparent cladding material which has a lower index of refraction than the core material. This core and cladding arrangement is generally referred to as a waveguide and a specific configuration of a waveguide is a free standing optical fiber comprised of core, cladding, and a protective outer jacket material.

Traditionally if the connection between optical components is made using an optical fiber the fiber is actively aligned to the microscopic mating target by monitoring the strength of an optical signal while adjusting the X, Y, and Z position of the fiber. When the maximum value of the signal has been found the X, Y, Z motion is stopped and the fiber is held rigidly in place while adhesive is applied and cured to act as a permanent bond which maintains the relative position between the fiber and the target.

For multimode fibers the core which carries the optical signal is generally on the order of 50 microns in diameter and must be aligned to the target within +/−10 microns in order to have acceptable optical coupling, generally defined as less than 1 dB optical signal loss due to creating the connection.

For single mode fibers with core diameters on the order of 10 micron the acceptable alignment tolerance is +/−1 micron in order to achieve the aforementioned 1 dB maximum loss due to creating the connection.

Challenges with current packaging techniques include the need for very tight alignment tolerances of the assemblies with subsequent high cost in positioning machines and labor. In addition current packaging technologies often require optical subcomponents such as lenses to change the shape of the transmitted beam between components to improve optical coupling efficiency.

### BRIEF SUMMARY OF THE INVENTION

The present invention includes a method for creating point to point optical links between two optical devices. The invention also provides method and apparatus for creating these point to point links which accommodates and corrects for misalignment of the individual optical components to be connected.

This invention eliminated the need for active alignment and also provides a means of tapering connections between devices to change the spot size or mode diameter of the signal being transmitted without the need for additional lenses or optical beam shapers.

In some embodiments of this invention the components to be linked reside on a single substrate such as a semiconductor chip.

In some embodiments of this invention the components to be linked reside on two or more separate optical devices and these separate optical devices are connected to a common substrate. Examples of substrates include silicon substrates, glass substrates, rigid backplane materials such as FR4, and flexible backplane materials such as polyamide.

In some embodiments of this invention the components to be linked are an optical emitter to an optical fiber. Examples of optical emitters include but are not limited to Vertical Cavity Surface Emitting Lasers (VCSELs), edge emitting semiconductor lasers, Light Emitting Diodes (LEDs), and the output waveguides of photonic processing circuits.

In some embodiments of this invention the components to be linked are an optical detector to an optical fiber. Examples of optical detectors include bt are not limited to photodiodes, PIN diodes, phototransistors, and Complementary Metal Oxide Semiconductor (CMOS) photo detectors.

In some embodiments of this invention the optical links may have different diameters at the start and end connections (tapers), Y splitters, star connections, bends, and other features known to those skilled in the art of creating polymer based photonic structures.

Yet another aspect of the invention provides methods and materials used to create the optical links. Methods of creating the links include deposition of the core material via jet printing, extrusion of core and cladding material for links that are not adhered to the supporting substrate, self-writing waveguides, photolithography in an optically curable material, and direct writing the links in an optically curable material. Materials used to create the optical links include Amoco Ultradel™, Dupont OASIC™, Exxelis TrueMode, and silicones (e.g. including but not exclusively limited to DOW Corning® OE-4140, Dow Corning® OE-4141, Dow Corning® WG-1017).

### BRIEF DESCRIPTION OF THE SEVERAL VIEWS OF THE DRAWING

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 shows two optical components with non-aligned optical axes which have been optically linked together.

FIG. 2 shows three optical components with non-aligned optical axes which have been linked together using an optical splitter.

FIGS. 3-6 show a cross section views of exemplary embodiments in which an optical device (emitter or detector) is linked to an optical fiber using a photo patterning process guided by an external control system.

FIG. 7 shows a cross section view of an exemplary embodiment in which an optical device (emitter or detector) is linked to an optical fiber using a tapered and self-written waveguide core.

FIG. 8 shows a block diagram of a manufacturing system used to create waveguides using an external control system to find the target attachment points and pattern the optical core.

FIG. 9 shows a cross section view of an exemplary embodiment in which an optical device (emitter or detector) is linked to an optical fiber using an extruded optical waveguide.

FIG. 10 shows a cross section of an exemplary embodiment of an extrusion system designed to create the core and cladding material simultaneously.

FIG. 11 shows an example first step in the connection process in which an edge emitting laser diode and a single mode optical fiber have been placed onto a common substrate.

FIG. 12 shows an example second step in the connection process in which an uncured optically curable polymer has been placed in the gap between the edge emitting laser diode and the single mode optical fiber.

FIG. 13 shows an example third step in the connection process in which appropriate radiation (light) has been coupled into the far end of the single mode fiber and has caused a small nub of cured polymer to form such that the cured material is exactly aligned with the core of the single mode fiber.

FIG. 14 shows an example fourth step in the connection process in which a focused spot of appropriate radiation (light) is moved from the termination of the nub to very close to the output of the edge emitting laser diode. The size of the focused spot is changed during the writing process such that the diameter of the waveguide is sized and shaped appropriately to couple into the fiber and to couple into the edge emitting laser diode.

FIG. 15 shows an example fifth step in the connection process in which appropriate radiation (light) has been coupled into the far end of the single mode fiber and creates the final connection to the face of the edge emitting laser diode.

FIG. 16 shows an example sixth step in the connection process in which the written waveguide is encapsulated in a cladding material which is characterized as having a lower refractive index than the waveguide core.

FIG. 17 shows a situation in which the focused spot of curing radiation is blocked from successfully writing a waveguide.

FIG. 18 shows the use of a self-written nub to allow the focused spot of curing radiation to successfully create a continuous waveguide.

### DETAILED DESCRIPTION OF THE INVENTION

Two or more optical components to be joined are fixed rigidly in space, generally on a substrate. These components are roughly aligned to each other and the substrate during package assembly. However the requirements for alignment of these components is sufficiently met by current high speed and low cost semiconductor packaging methods including but not limited to the creation of V-grooves or alignment ridges in the substrate, pick and place machines, manual alignment, self-alignment due to surface tension during solder bonding, and the addition of passive alignment features such as hard stops. The optical axes of the components to be joined in general will not be perfectly coaxial or parallel.

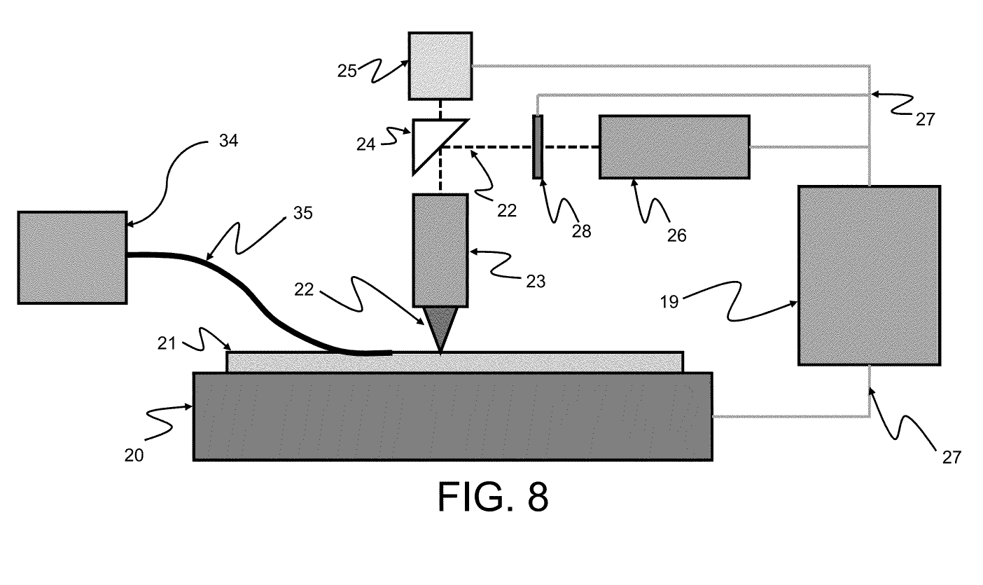

FIG. 8 shows an exemplary embodiment of a manufacturing system for creating optical links. Control lines 27 transmit information and control signals among the control system 19, the motion system 20, the camera 25, illumination system 26, and optical conditioning system 28. The optical conditioning system 28 may contain filters, polarizers, attenuators, beam shapers, and other components necessary to correctly create the desired waveguide structures. The light 22 used to expose the photosensitive waveguide polymer is directed toward a beam splitter 24. The beam splitter 24 allows the imaging system to view the targets to be connected through the same optical system used to perform the writing. In other embodiments in which combining the imaging and writing into a single optical path is not possible the control system 19 will be calibrated with appropriate coordinate offsets to assure that the waveguide is written in the proper location as defined by the imaging optics.

An additional source of radiation 34 of the appropriate wavelength to cure the photosensitive polymer may additionally be present and coupled into an optical fiber 35 or other appropriate conduit. This coupled light may be directed along the optical fiber 35 and into the optical assembly in such a way that it is emitted into the photosensitive polymer at locations where optical connections will terminate. The control system 19 is used to manage the timing and duration of the application of radiation from the external source 34. The substrate 21 which supports the items to be linked as well as an unexposed layer of the photosensitive polymer is rigidly affixed to the motion system 20. The control system then uses the camera 25 to find the start and end positions of the link to be formed by locating the optical targets to be joined. After the start and end positions of the link have been determined the control system 19 calculates the appropriate motion path for creation of the link. The control system 19 then commands the motion system 20 to move and also controls the illumination system 26 and optical conditioning system 28 to expose the photosensitive polymer to create the optical waveguide link.

The process of finding start and end points and writing waveguide links is repeated until all necessary connections have been made. After all connections are completed the substrate 21 is removed from the motion system for subsequent processing.

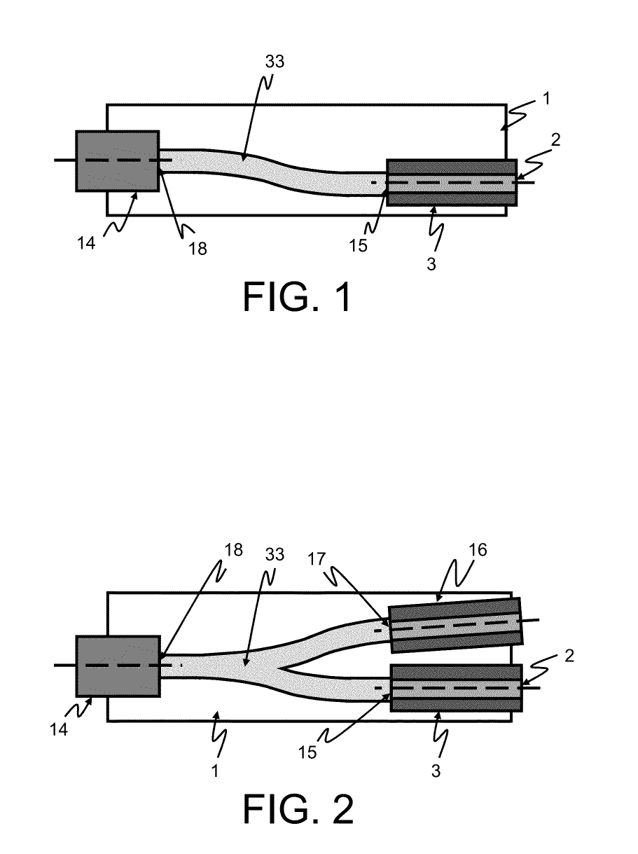

FIG. 1 shows a top-down view of two optical components 3, 14 and a waveguide link 33 created using the present method. The lower refractive index cladding material is not shown here for clarity but is known to those skilled in the art to be a required part of a functioning embodiment of the current invention. The manufacturing system shown in FIG. 8 will find the proper optical attachment points 15, 18 for the waveguide link 33 and calculate the path along the centerline of the waveguide link 33. The manufacturing system will then write the waveguide link 33 using the process described by FIG. 8.

In a similar manner, FIG. 2 shows a top down view of three optical components 3, 14, 16 to be joined by a Y waveguide 33 using the present method. The manufacturing system shown in FIG. 8 will find the proper optical attachment points 15, 17, 18 for the waveguide link 33 and calculate the path along the centerline of the waveguide link 33. The manufacturing system will then write the waveguide link 33 using the process described by FIG. 8.

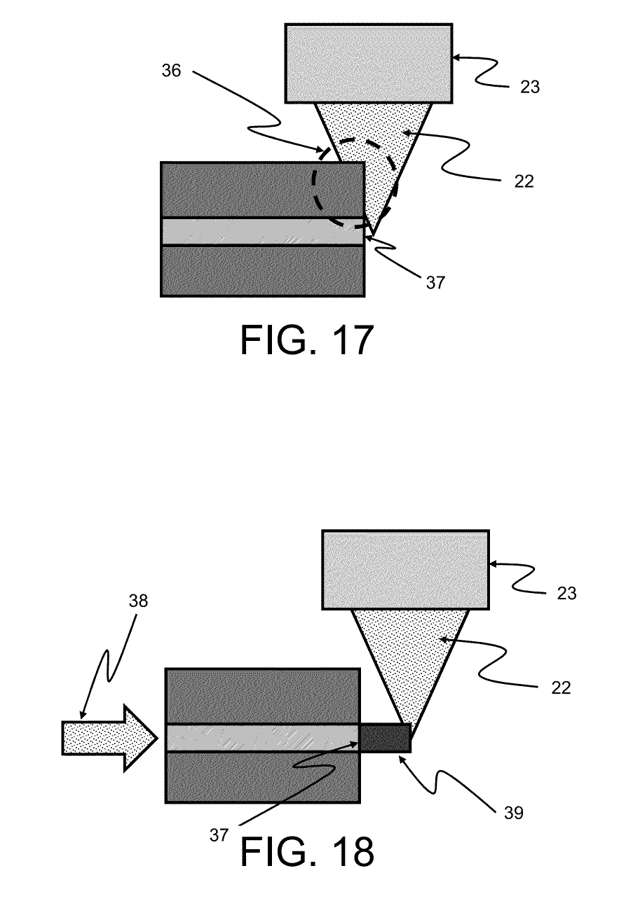

In some embodiments of the current invention the focused spot of radiation shown in FIG. 8 cannot be placed in a manner that forms a proper optical bond to an optical component. An example of such a situation is shown in FIG. 17. In FIG. 17 the focusing objective 23 is creating a focused spot at the tip of the radiation cone 22. The radiation cone 22 is being blocked by the target object in the region 36. Due to this blockage the size and shape of the cured photopolymer will not be correct and will not properly couple with the exit face 37 of the device. FIG. 18 shows one method to address this issue using appropriate radiation 38 coupled into the device such that it is emitted from the exit face 37 of the device to be connected. The radiation 38 is created by the radiation source 34 shown in FIG. 8 and is guided to the device to be connected using the optical conduit 35 shown in FIG. 8. When the radiation 38 is emitted from the exit face of the device to be connected, a small nub 39 of the photopolymer will cure and the length of this nub 39 may be controlled by the intensity, duration, and modulation of the radiation 38. The creation of the nub 39 using this process is commonly referred to as self-writing. The cone of light 22 used to create the waveguide can now be focused at the tip of the nub 39 without being blocked by any parts of the component to be connected.

It should also be noted that the process shown in FIG. 18 confers additional benefit when making optical connections. Because the light 38 is emitted from the exit face 37 of the device to be connected, the nub 39 is perfectly aligned with the exit face. Such self-written waveguides have been shown to produce optical connections with very low loss due to self-aligning nature of their creation. In some embodiments of the present invention, self-written waveguides alone may be sufficient to create an optical link with acceptable optical losses.

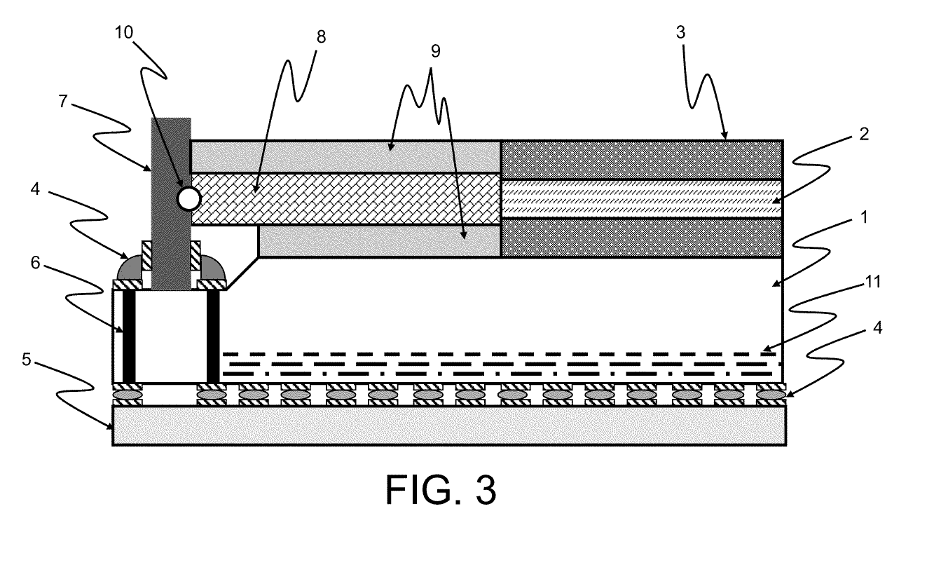

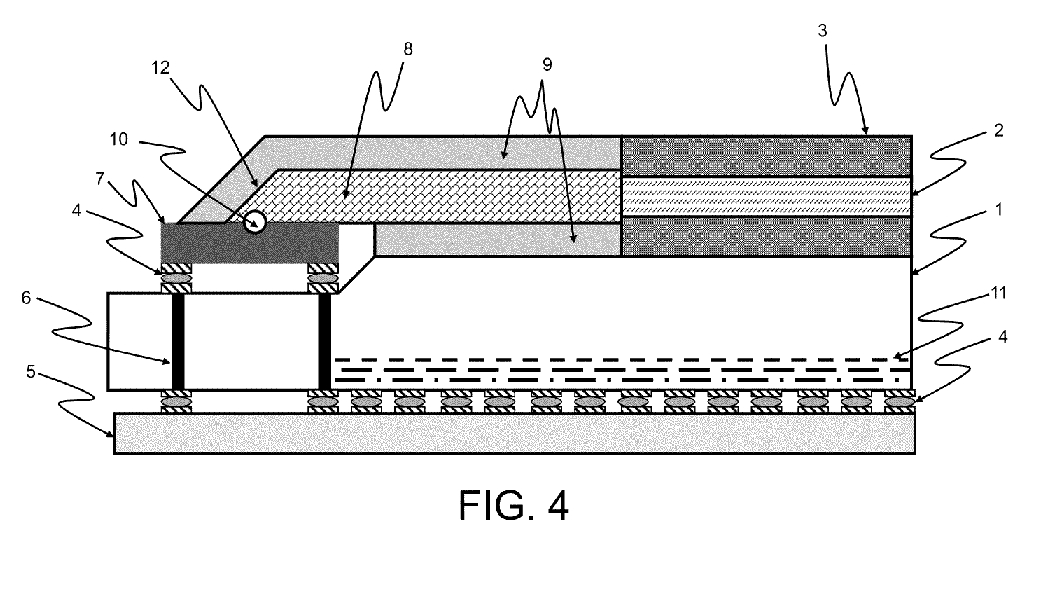

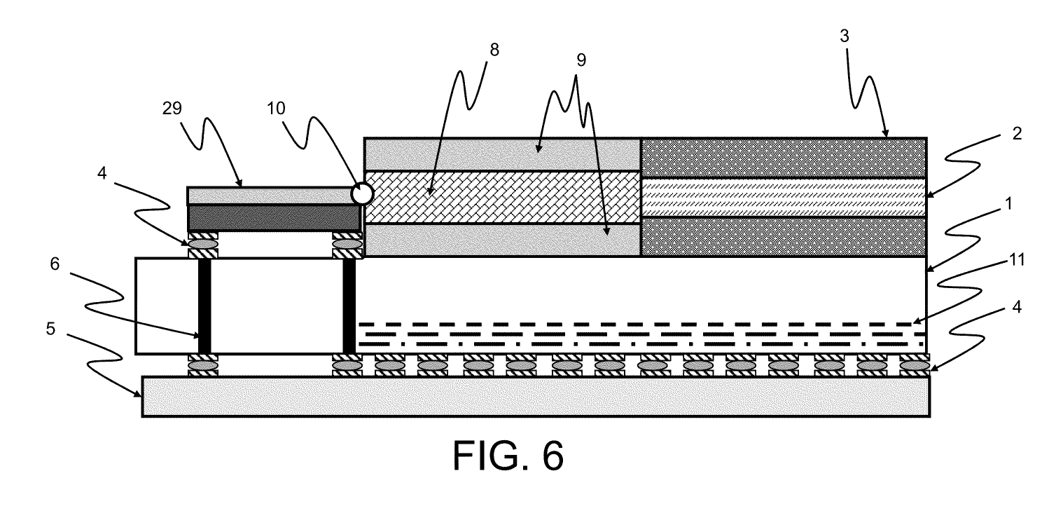

FIGS. 3-6 show exemplary assemblies of optical devices connected to an optical fiber 3 using the manufacturing system shown in FIG. 8. In some of these examples the creation of a nub 39 at the start, end, or both ends of the written waveguide may be necessary due to the geometry of the particular application. The optical devices shown are VCSELs or optical detectors 3, and edge emitting lasers or monolithically integrated photonics 29. The manufacturing system shown in FIG. 8 locates the optical attachment point 10 of the optical device and the core 2 of the optical fiber 3 and writes a waveguide cladding 9 and core 8 between the device's attachment point 10 and the optical fiber 3. Prior to the process of writing the waveguide 8,9 on the substrate 1, the optical components are attached to the substrate 1 using standard semiconductor packaging techniques. An example of such a technique is the use of the surface tension in the solder 4 to self-align the optical components 7 to the substrate 1. The substrate 1 may also contain electrical through connections (vias) 6 as well as internal electrical routing layers 11 to allow devices 5 such as memory and logic to be attached to the bottom side of the substrate 1.

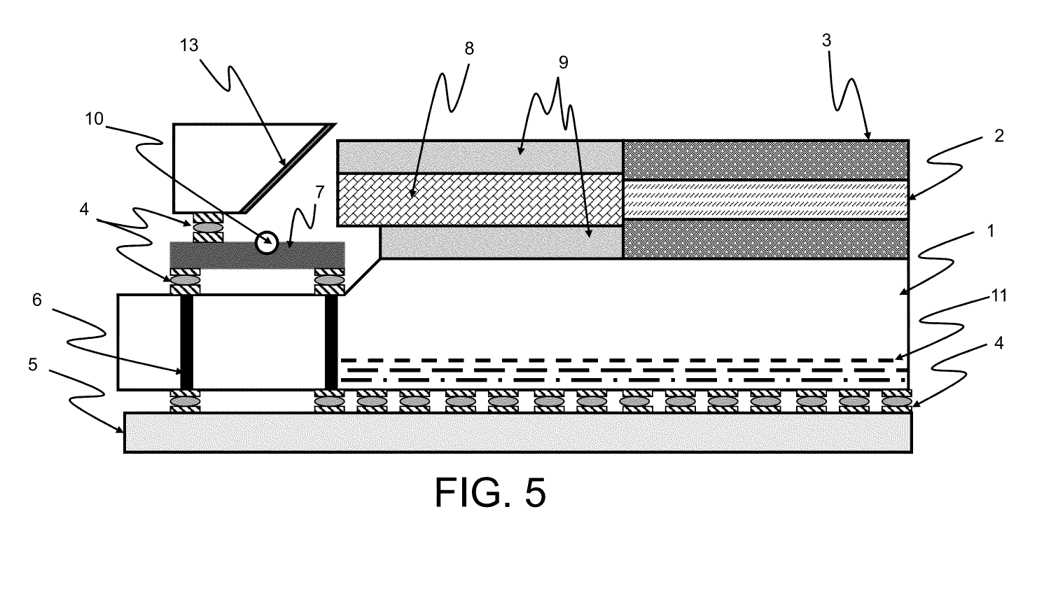

FIG. 5 additionally shows a MEMS mirror 13 that is bonded to the optical device 7 using the surface tension of the solder 4 for self-alignment. It should be noted that MEMS devices may also be actively adjusted prior to fixing their orientation such that the transmitted signal is optimized. The present invention does not require this active adjustment but also does not preclude its use.

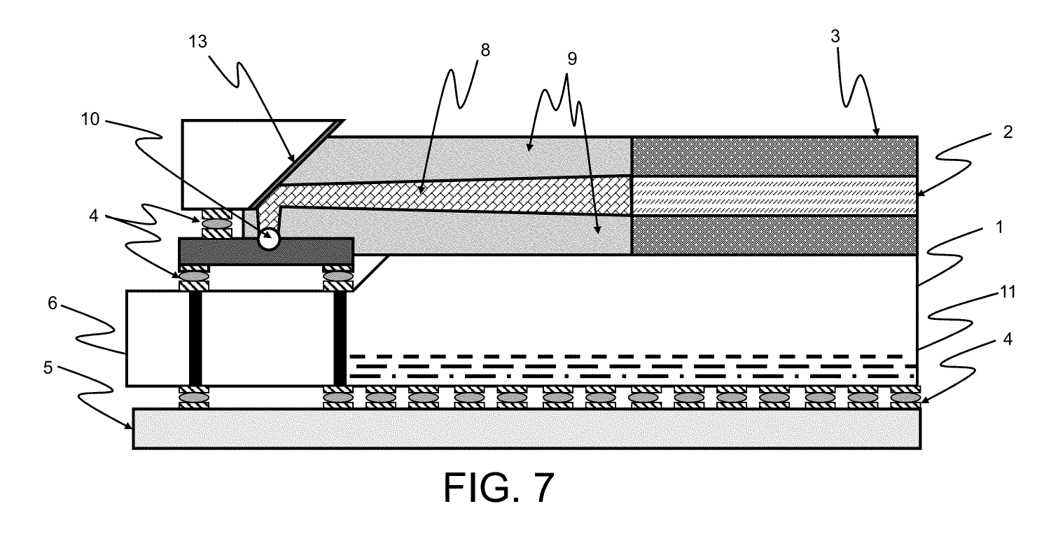

FIG. 7 shows a polymer link 8,9 that is created using a self-writing waveguide process. In this process the unexposed core material 8 is spread onto the substrate 1 and bottom cladding layer 9. Then light of an appropriate wavelength (generally ultraviolet) is coupled into the far end of the fiber core 3. This curing light will selectively cure the core material in perfect alignment with the existing fiber core 3. After reaching the turning mirror 13 the curing light will complete the optical connection to the device output 10.

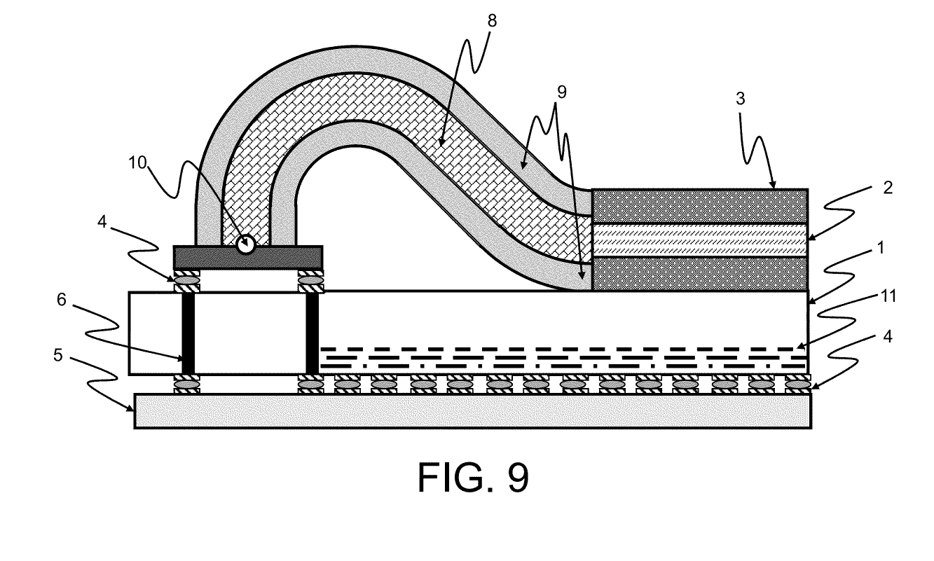

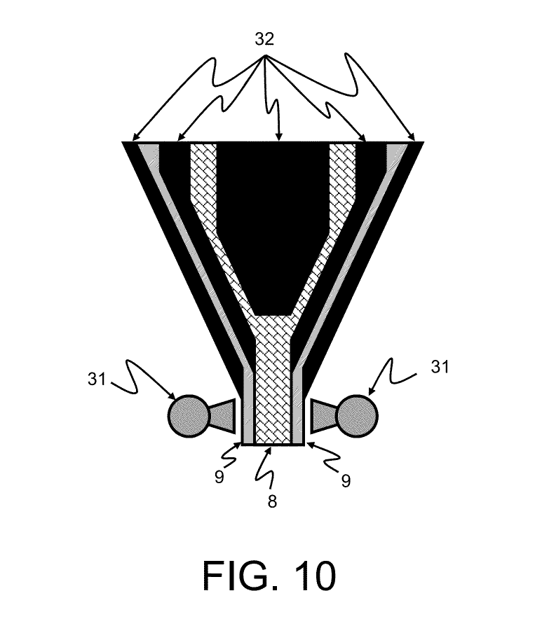

FIG. 9 shows a cross section of an exemplary embodiment of a co-extruded optical link in which the core 8 and cladding 9 are extruded in a continuous manner using an extrusion head similar to that shown in FIG. 10. In a manner similar to prior descriptions the optical connection point on the device 10 is located and the optical connection point to the core 3 of the fiber 2 is located. The extrusion system shown in FIG. 10 is then used to create a free-standing optical link 8,9 that is not required to be attached to the substrate 1.

FIG. 10 shows a cross section of an exemplary extrusion system used to create the optical link shown in FIG. 9. The uncured core 8 and cladding 9 polymer are forced out through an annular nozzle 32. Upon exiting the nozzle 32 the core 8 and cladding 9 are cured using illuminators 31 emitting the proper wavelength for polymer curing (Generally ultraviolet). It should be apparent to one skilled in the art that enabling an extrusion process as shown in FIG. 9 requires the addition of several axes of motion to the manufacturing system shown in FIG. 8.

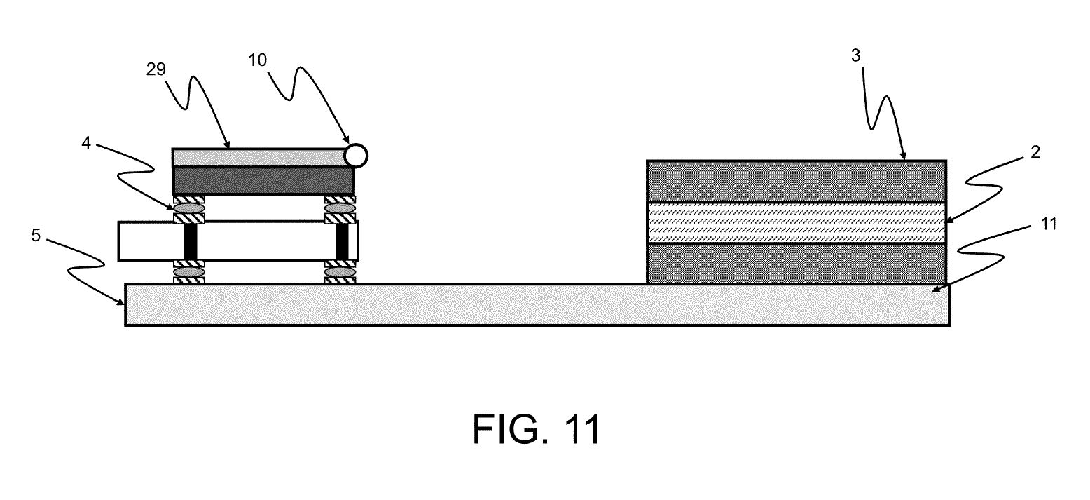

FIG. 11 shows the first step in a typical connection process. In this example an edge emitting laser diode 29 has an output face 10 located on a vertical face of the laser diode. An optical fiber 3 with a core 2 is the second target for the connection process. Both the laser diode and the optical fiber are rigidly attached to the supporting substrate 11 using common assembly techniques such as solder reflow, V-grooves, or other low-cost moderately accurate alignment methods.

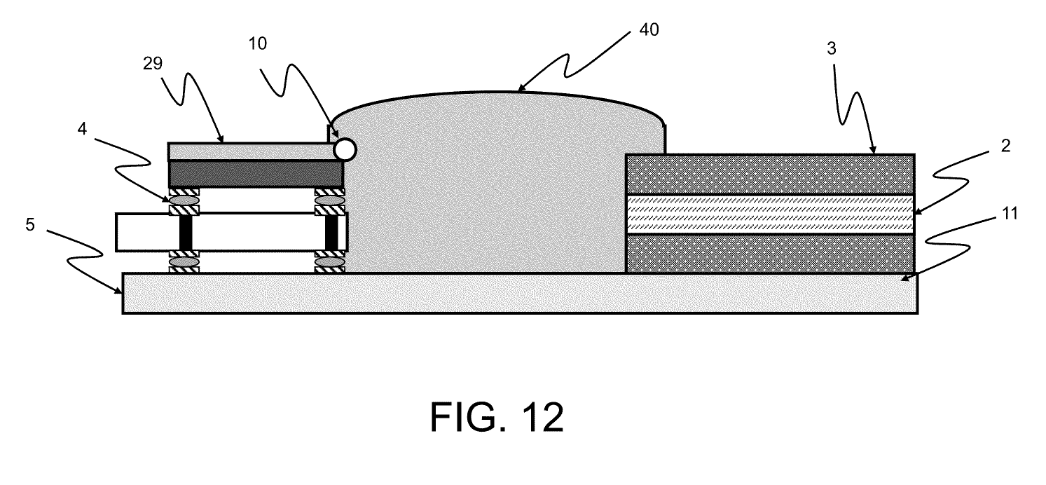

FIG. 12 shows the application of uncured photopolymer 40 in the gap between the optical fiber 3 and the laser diode output face 10. The polymer may be applied using any manner of dispensing systems that control its temperature, viscosity, and location and amount of material placed into the gap.

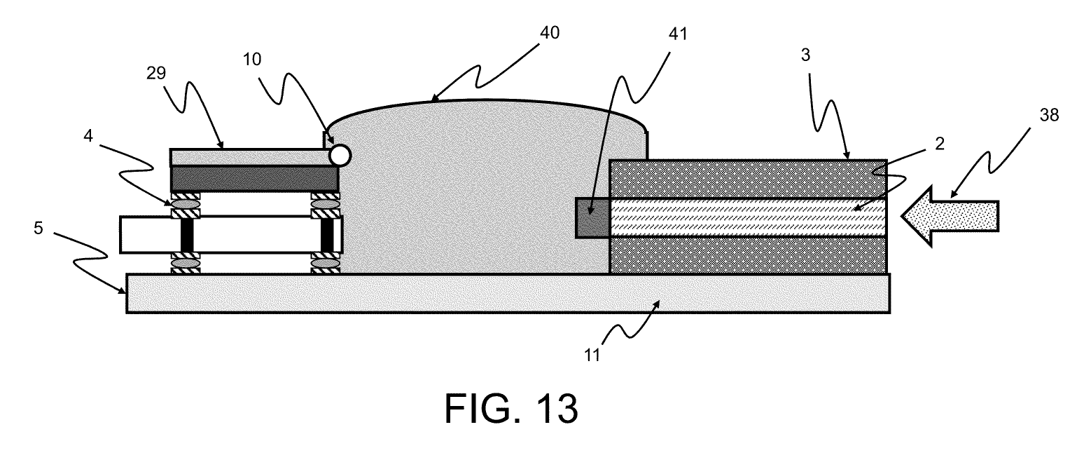

FIG. 13 shows the application of radiation 38 coupled into the fiber core 2 to create a small nub 41 that is perfectly aligned with the fiber core. This nub serves to create a perfectly aligned connection to the fiber and also to allow the cone of light 23 to be focused inside the polymer without being disturbed by the presence of the fiber 3.

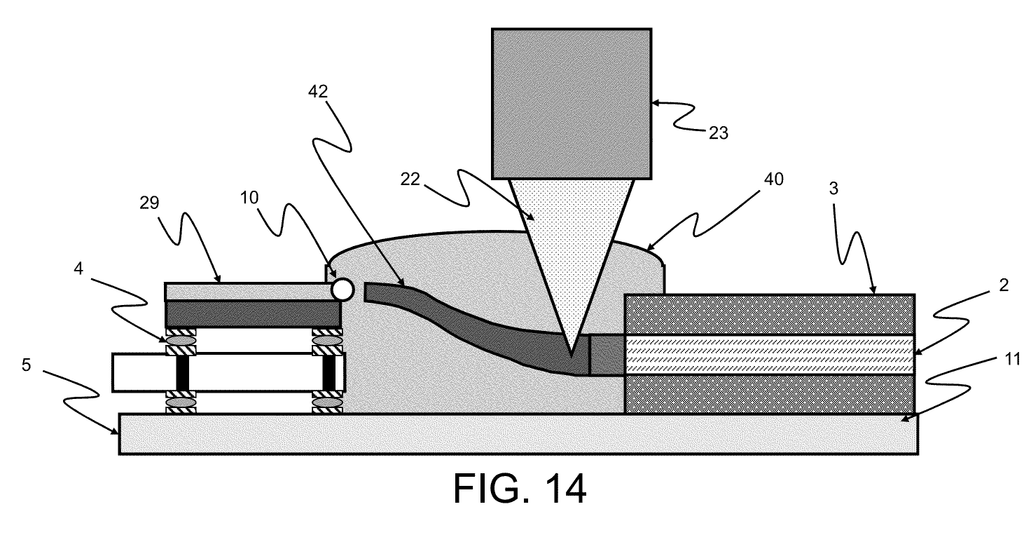

FIG. 14 shows the creation of the correctly curved and sized waveguide 42 between the nub 41 and the laser diode emitting face 10. In this example the curved waveguide is not written completely to contact the emitting face 10 of the laser diode because the laser diode substrate 29 will block the cone of light 22. FIG. 14 also shows the change in diameter and shape of the waveguide as it is written such that it couples properly with both the fiber and the laser diode.

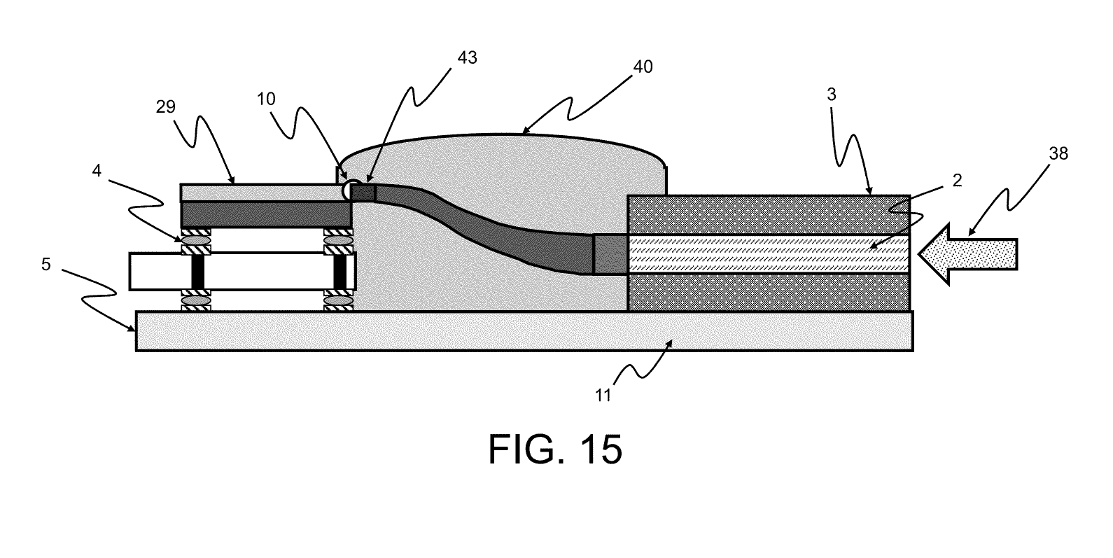

FIG. 15 shows the application of radiation 38 coupled into the fiber core 2 and through the nub 41 and waveguide 42 to create a final nub 43 that completes the optical link from the laser diode to the optical fiber.

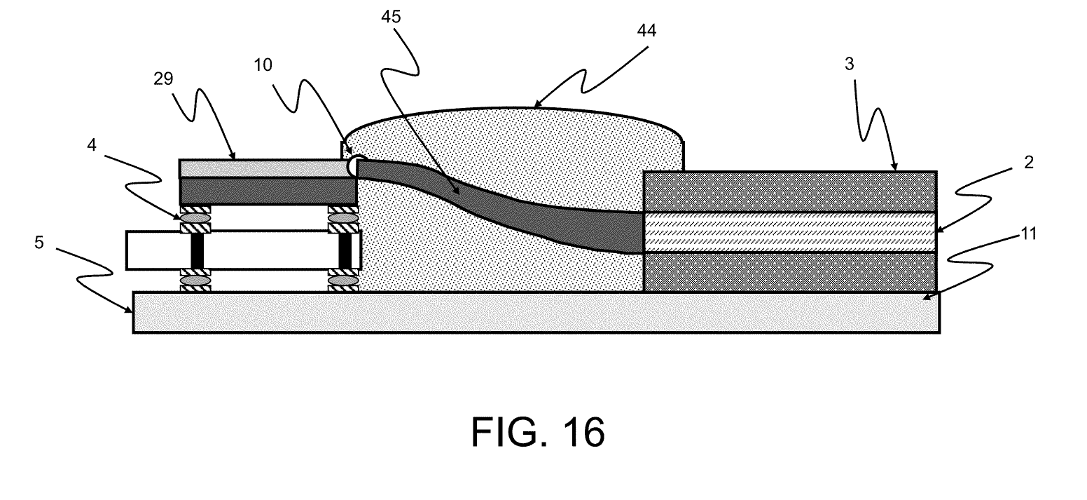

FIG. 16 shows the cladding material 44 surrounding the entire waveguide 45. The cladding material 44 is known to those skilled in the art to require a lower index of refraction than is present in the waveguide 45. Methods of generating this lower index of refraction in the cladding include but are not limited to:
1. Replacing the uncured polymer 40 with a cladding polymer 44
2. Curing the waveguide 45 with a particular wavelength of light and curing the cladding with a different process such as heat or a different wavelength of light.
3. Creating the waveguide 45 at one temperature to promote polymerization of the desired high index and curing the cladding 44 at a different temperature to promote polymerization at the desired lower index
4. Utilize diffusion of high index polymer material into the waveguide 45 to selectively deplete the area immediately surrounding the waveguide 45 of high index polymer molecules and subsequently flash curing the bulk polymer 44 to “lock in” the depletion layer as a lower index cladding.
5. Utilize a means of forcing species migration to move the high index polymer species away from the waveguide 45 before bulk curing the cladding material 44. Forcing mechanisms include but are not limited to temperature gradients, electrical potentials, magnetic fields, and chemical gradients.

It should be noted that working with the uncured polymer 40 in a liquid or gel state presents challenges associated with bulk flow of the polymer due to capillary and other wetting related forces. When flow is present the waveguide 45 may be displaced from its desired position and subsequently suffer from increased optical losses due to misalignment. Thus the viscosity of the uncured polymer 40 is preferred to be very high. However a very high viscosity polymer will not tend to self-level or become flattened at the top of the pool of liquid polymer. A smooth profile at the top of the uncured polymer is desirable to prevent unwanted deviations of the cone of light 22 from the intended waveguide location.

Thus the viscosity of the uncured polymer is generally preferred to be in the range of 1000 centipoise to 100,000 centipoise and more preferably in the range of 5,000 centipoise to 25,000 centipoise.

It is also apparent that the process of replacing the uncured waveguide polymer 40 with a lower index of refraction cladding polymer 44 carries the risk of displacing or breaking the waveguide 45, particularly if the waveguide polymer 40 is highly viscous.

Thus is it noted that this invention may also be practiced in a polymer material that has been soft-cured prior to the creation of the waveguide to eliminate the flow forces in the bulk polymeric material. If used, a soft-cure is performed immediately following the application of the polymer in the gap between optical endpoints and before the waveguide is written. Using a soft-cure process precludes the replacement of uncured waveguide polymer with a lower index cladding polymer. However the soft-cure process simplifies the implementation of the present invention in a high volume manufacturing setting.

Because the present invention include the use of radiation coupled into the waveguides to be connected, the wavelength of light used to cure the polymer must be selected to allow efficient transmission of the light through an optical fiber or waveguide structure for a useful distance, for example 2-4 meters. Very short wavelengths below about 350 nm are rapidly attenuated in optical fibers commonly used in data transmission. In addition it is advantageous that the polymer used for the waveguide and cladding is transparent to and not affected by the data signals being transmitted and these are generally in the wavelength range of 800 nm up to 1550 nm and longer.

Thus the curing wavelength for the waveguide polymer should be bounded in the range of 350 nm up to 800 nm and more preferably in the range of 400 nm to 600 nm.

What is claimed is:

1. A method of creating optical links among optical components the method comprising:
Accommodation of optical components which are not aligned to one another Calculating optimized optical link paths to correct for component misalignment Creating optical links along the optimized path using polymeric materials that are cured using visible light
Creating a waveguide core in which one or more segments of the link are created using self-writing processes
Creating a cladding around the waveguide core which is of lower index of refraction than the waveguide core

2. The method in claim 1 in which the optical link path is defined using a vision system to locate the start and end paths for the link

3. The method in claim 1 in which the entire optical link is created by emitting curing light from the end of an optical element to self-write a waveguide perfectly aligned to said optical element

4. The method in claim 1 in which a self-written nub beginning the optical link is created by emitting curing light from the end of an optical element to assure that the waveguide is perfectly aligned to said optical element

5. The method in claim 1 in which a waveguide is written using a self-written nub as the starting point of the writing process

6. The method in claim 1 in which a nub is created at the end of the optical link path to complete the link path

7. The method in claim 1 in which a self-written segment is written at any location along the waveguide path where the path is not accessible to a focused spot of light

8. The method in claim 1 in which the optical link is written using a focused point of light which is moved relative to the optical components to be linked

9. The method of claim 1 in which the optical link is defined using a transmissive LCD to generate a custom exposure mask

10. The method in claim 1 in which the optical link is created by extruding optical core and cladding material

11. The method in claim 1 in which the curing light is blue or ultraviolet light of wavelength less than 500 nm

12. The method in claim 1 in which the curing light is green light of wavelength in the range of 500 nm to 600 nm

13. The method in claim 8 in which the photosensitive material is moved relative to the point of light

14. The method in claim 8 in which the point of light is moved relative to the photosensitive material

15. The method of claim 8 in which the motion of the point of light is accomplished using an X, Y, Z motorized stage

16. The method of claim 8 in which the motion of the point of light is accomplished using a galvanometer scanning system

17. The method of claim 8 in which the motion of the point of light is accomplished using an acousto-optical device (AOD)

18. The method of claim 8 in which the motion of the point of light is accomplished using a transmissive element such as an LCD

19. The method of claim 8 in which the control system changes the size of the waveguide between the devices to be connected

20. The method of claim 8 in which the control system changes the shape of the waveguide between the devices to be connected

21. The method of claim 1 in which the low index cladding is created by replacing the uncured core media with an appropriate cladding polymer

22. The method of claim 1 in which the low index cladding is created by curing the waveguide with light and curing the cladding with heat

23. The method of claim 1 in which the low index cladding is created by curing the waveguide with one particular wavelength of light and curing the cladding with a different wavelength of light

24. The method of claim 1 in which the low index cladding is created by curing the waveguide at one particular temperature and curing the cladding at a different particular temperature

25. The method of claim 1 in which the low index cladding is created by the process of depleting high index polymeric species in the region surrounding the waveguide during waveguide creation

26. The method of claim 1 in which the low index cladding is created by curing the waveguide and subsequently forcing the migration of polymeric species away from the waveguide before curing the bulk material as a low index cladding

27. The method of claim 1 in which the polymer material has an uncured viscosity in the range of 1000 centipoise to 25,000 centipoise

28. The method of claim 1 in which the polymer material is soft-cured prior to the formation of the waveguide
